(19) United States
(12) Patent Application Publication
(10) Pub. No.: US 2025/0116777 A1
(43) Pub. Date: Apr. 10, 2025

(54) Vehicle Control Apparatus and Method Thereof

(71) Applicants: Hyundai Motor Company, Seoul (KR); Kia Corporation, Seoul (KR)

(72) Inventor: Woo Cheol Choi, Incheon (KR)

(21) Appl. No.: 18/740,919

(22) Filed: Jun. 12, 2024

(30) Foreign Application Priority Data
Oct. 4, 2023 (KR) 10-2023-0131867

(51) Int. Cl. G01S 17/89; G01S 17/06; G01S 17/931

(52) U.S. Cl. CPC G01S 17/89; G01S 17/06; G01S 17/931

(57) ABSTRACT

A vehicle control apparatus and a method thereof are provided. The vehicle control apparatus includes a sensor (e.g., light detection and ranging (LiDAR)) and a processor. The processor obtains, while a first vehicle is operating and based on a specified algorithm applied to a virtual box corresponding to a second vehicle, a first vector in a plurality of frames that are obtained using the sensor, obtains a second vector indicating the direction of movement of the second vehicle, obtains a third vector indicating a heading direction of the virtual box, based on an angle between a straight line, perpendicular to one side of the virtual box, and the second vector, determines a reliability range based on a plurality of vectors including the third vector, and adjusts the heading direction of the virtual box, using all least one of the plurality of vectors.

### CROSS-REFERENCE TO RELATED APPLICATION

This application claims the benefit of priority to Korean Patent Application No. 10-2023-0131867, filed in the Korean Intellectual Property Office on Oct. 4, 2023, the entire contents of which are incorporated herein by reference.

### TECHNICAL FIELD

The present disclosure relates to a vehicle control apparatus and a method thereof, and more particularly, relates to technologies of identifying an external object using a sensor, such as a light detection and ranging (LiDAR) device.

### BACKGROUND

Various studies for identifying an external object using various sensors have been in progress to assist with driving of a vehicle.

Particularly, while the vehicle is operating in a driving aid activation mode or an autonomous driving mode, some implementations of vehicle control apparatus may identify an external object using light detection and ranging (LiDAR), identify the direction of movement (or a motion direction) of the identified external object, and may predict a movement path of the external object, thus preventing an accident.

Some implementations of vehicle control apparatus may identify a heading direction of a virtual box corresponding to an external object identified at a current time using a movement vector of the external object, a tracking history of the external object, and/or the amount of movement of the vehicle in the data obtained using the LiDAR. However, because available information may dependent on a shape of the virtual box corresponding to the external object identified at the current time, a heading direction of the virtual box that is formed with V- or U-shaped points can be incorrectly identified.

### SUMMARY

The present disclosure has been made to solve the above-mentioned problems occurring in some implementations while advantages achieved by those implementations are maintained intact.

An aspect of the present disclosure provides a vehicle control apparatus for correcting a heading direction of an external vehicle obtained using LiDAR and a method thereof.

Another aspect of the present disclosure provides a vehicle control apparatus for correcting a heading direction of a virtual box corresponding to an external vehicle, when a vehicle operates in a driving aid activation mode or an autonomous driving mode to prevent an accident and a method thereof.

Another aspect of the present disclosure provides a vehicle control apparatus for correcting a heading direction of a virtual box corresponding to an external vehicle, when a vehicle operates in a driving aid activation mode or an autonomous driving mode to prevent the operation of a vehicle control system including the vehicle control apparatus from being stopped and a method thereof.

The technical problems to be solved by the present disclosure are not limited to the aforementioned problems, and any other technical problems not mentioned herein will be clearly understood from the following description by those skilled in the art to which the present disclosure pertains.

According to one or more example embodiments of the present disclosure, a vehicle control apparatus may include: a sensor; and a processor configured to: obtain, while a first vehicle is operating and based on a specified algorithm applied to a virtual box corresponding to a second vehicle, a first vector in a plurality of frames that are obtained using the sensor; obtain, based on at least one of the first vector or a speed of the first vehicle, a second vector indicating a direction of movement of the second vehicle; obtain a third vector indicating a heading direction of the virtual box, based on an angle between a straight line, perpendicular to one side of the virtual box, and the second vector; determine a reliability range based on a plurality of vectors including the third vector; and adjust, based on the heading direction deviating from the determined reliability range, the heading direction of the virtual box, using at least one of the plurality of vectors. The plurality of vectors may be determined in the plurality of frames

The processor may be configured to obtain the first vector by: obtaining the first vector further based on an amount of movement of the second vehicle. The amount of movement may be obtained based on a displacement, in the plurality of frames, of a representative point included in the virtual box.

The vehicle control apparatus may further include memory. The processor may be configured to obtain the first vector by: obtaining the first vector based on applying the specified algorithm to a sampling point of the virtual box included in the plurality of frames; and storing the obtained first vector in the memory.

The vehicle control apparatus may further include memory. The processor may be further configured to: determine, based on at least one of an amount of change along an x-axis of the virtual box or an amount of change along a y-axis of the virtual box, directivity indicated by the virtual box; and classify, based on the determined directivity, and store the obtained first vector in a specified area of the memory.

The processor may be configured further to: adjust the heading direction of the virtual box, based on an average of the at least one of the plurality of vectors.

The processor may be further configured to: change the determined reliability range, based on at least one of a speed of the second vehicle or a size of the virtual box.

The vehicle control apparatus may further include: memory storing the plurality of vectors. The processor may be further configured to excluding the adjusted heading direction of the virtual box from the plurality of vectors.

The processor may be further configured to: determine the heading direction of the virtual box by determining a side of the virtual box having, among sides of the virtual box, a smallest angle between the straight line, perpendicular to the side of the virtual box, and the second vector.

The vehicle control apparatus may further include memory. The processor may be further configured to: sequentially store the first vector in one of a plurality of areas formed in the memory.

The processor may be configured to: determine the reliability range by determining the reliability range based on a measure of dispersion indicated by the plurality of vectors; and adjust the heading direction of the virtual box by adjusting the heading direction of the virtual box based on an average, in the measure of dispersion, of the at least one of the plurality of vectors in the reliability range.

The processor may be further configured to: obtain a fourth vector corresponding to the average of the at least one of the plurality of vectors; and obtain, based on an angle between the straight line and the fourth vector, a fifth vector including the heading direction of the virtual box and adjust the heading direction of the virtual box.

According to one or more example embodiments of the present disclosure, a vehicle control method may include: obtaining, by a processor while a first vehicle is operating and based on a specified algorithm applied to a virtual box corresponding to a second vehicle, a first vector in a plurality of frames that are obtained using a sensor; obtaining, based on at least one of the first vector or a speed of the first vehicle, a second vector indicating a direction of movement of the second vehicle; obtaining a third vector indicating a heading direction of the virtual box, based on an angle between a straight line, perpendicular to one side of the virtual box, and the second vector; determining a reliability range based on a plurality of vectors including the third vector; and adjusting, based on the heading direction deviating from the determined reliability range, the heading direction of the virtual box, using at least one of the plurality of vectors. The plurality of vectors may be determined in the plurality of frames.

Obtaining the first vector may include: obtaining the first vector further based on an amount of movement of the second vehicle. The amount of movement may be obtained based on a displacement, in the plurality of frames, of a representative point included in the virtual box.

Obtaining the first vector may include: obtaining the first vector based on applying the specified algorithm to a sampling point of the virtual box included in the plurality of frames; and storing the obtained first vector in a memory.

The vehicle control method may further include: determining, based on at least one of an amount of change along an x-axis of the virtual box or an amount of change along a y-axis of the virtual box, directivity indicated by the virtual box; and classifying, based on the determined directivity, and storing the obtained first vector in a specified area of a memory.

The vehicle control method may further include: adjusting the heading direction of the virtual box, based on an average of the at least one of the plurality of vectors.

The vehicle control method may further include: changing the determined reliability range, based on at least one of a speed of the second vehicle or a size of the virtual box.

The vehicle control method may further include: excluding the adjusted heading direction of the virtual box from being stored in memory.

The vehicle control method may further include: determining the heading direction of the virtual box by determining a side of the virtual box having, among sides of the virtual box, a smallest angle between the straight line, perpendicular to the side of the virtual box, and the second vector.

The vehicle control method may further include: determining the reliability range by determining the reliability range based on a measure of dispersion indicated by the plurality of vectors; and sequentially storing the first vector in one of a plurality of areas formed in memory.

### BRIEF DESCRIPTION OF THE DRAWINGS

The above and other objects, features and advantages of the present disclosure will be more apparent from the following detailed description taken in conjunction with the accompanying drawings:

FIG. 1 illustrates an example of a block diagram of a vehicle control apparatus.

FIG. 2 illustrates an example associated with a representative point of a virtual box corresponding to an external object using LiDAR included in a vehicle control apparatus;

FIG. 3 illustrates an example of obtaining a vector indicating the direction of progress of an external vehicle;

FIG. 4 illustrates an example of directivity of a virtual box;

FIG. 5 illustrates an example of vectors including a heading direction of a virtual box stored in a memory;

FIG. 6 illustrates an example of obtaining a vector including a heading direction of a virtual box;

FIG. 7 illustrates an example of correcting a heading direction of a virtual box;

FIG. 8 illustrates an example of a result of correcting a heading direction of a virtual box;

FIG. 9 illustrates an example of a flowchart about a vehicle control method;

FIG. 10 illustrates an example of a flowchart about a vehicle control method; and

FIG. 11 illustrates a computing system including a vehicle control apparatus.

### DETAILED DESCRIPTION

Hereinafter, one or more example embodiments of the present disclosure will be described in detail with reference to the exemplary drawings. In adding the reference numerals to the components of each drawing, it should be noted that the identical component is designated by the identical numerals even when they are displayed on other drawings. In addition, a detailed description of well-known features or functions will be ruled out in order not to unnecessarily obscure the gist of the present disclosure.

In describing components of example embodiments of the present disclosure, the terms first, second, A, B, (a), (b), and the like may be used herein. These terms are only used to distinguish one component from another component, but do not limit the corresponding components irrespective of the order or priority of the corresponding components. Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

A vehicle control apparatus included in a vehicle may generate a virtual box corresponding to an external vehicle, using datasets obtained by means of a sensor, such as LiDAR, and may track the generated virtual box. The vehicle control apparatus may identify the direction of progress of the virtual box corresponding to the external vehicle. When the external vehicle is covered by another external vehicle or when the shape of the external vehicle is unclearly identified, the direction of progress of the virtual box corresponding to the external vehicle may be identified as being different from the actual direction of progress of the external vehicle.

Hereinafter, a description will be given of one or more example embodiments of adjusting (e.g., correcting) a heading direction of the virtual box, such that the heading direction of the virtual box corresponding to the external vehicle is identified as the same direction as the direction of progress of the actual external vehicle.

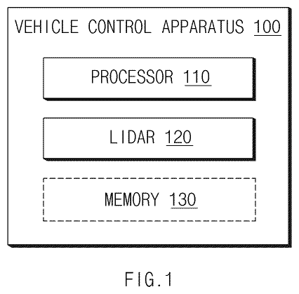

Hereinafter, one or more example embodiments of the present disclosure will be described in detail with reference to FIGS. 1 to 11.

FIG. 1 illustrates an example of a block diagram of a vehicle control apparatus.

Referring to FIG. 1, a vehicle control apparatus 100 disclosure may be implemented inside or outside a vehicle, and some of components included in the vehicle control apparatus 100 may be implemented inside or outside the vehicle. In this case, the vehicle control apparatus 100 may be integrally configured with control units in the vehicle or may be implemented as a separate device to be connected with the control units of the vehicle by a separate connection means. For example, the vehicle control apparatus 100 may further include components which are not shown in FIG. 1.

Referring to FIG. 1, the vehicle control apparatus 100 may include a processor 110 and a sensor, such as LiDAR 120. The vehicle control apparatus 100 may further include a memory 130. The processor 110, the LiDAR 120, and the memory 130 may be electronically or operably coupled with each other by an electronical component including a communication bus.

Hereinafter, that pieces of hardware are operably coupled with each other may include that a direct connection or an indirect connection between the pieces of hardware is established in a wired or wireless manner, such that second hardware is controlled by first hardware among the pieces of hardware.

The different blocks are illustrated, but the disclosure is not limited thereto. Some of the pieces of hardware of FIG. 1 may be included in a single integrated circuit including a system on a chip (SoC). Types of the pieces of hardware included in the vehicle control apparatus 100 or the number of the pieces of hardware are limited to those shown in FIG. 1. For example, the vehicle control apparatus 100 may include only some of the pieces of hardware shown in FIG. 1.

The vehicle control apparatus 100 may include hardware for processing data, based on one or more instructions. The hardware for processing the data may include the processor 110. For example, the hardware for processing the data may include an arithmetic and logic unit (LU), a floating point unit (FPU), a field programmable gate array (FPGA), a central processing unit (CPU), and/or an application processor (AP).

The processor 110 may have a structure of a single-core processor or may have a structure of a multi-core processor including a dual core, a quad core, a hexa core, or an octa core. However, it is not limited thereto.

The sensor (e.g., LiDAR 120) included in the vehicle control apparatus 100 may obtain datasets for identifying a surrounding thing of the vehicle control apparatus 100. For example, the LiDAR 120 may identify at least one of a position of the surrounding thing, a motion direction of the surrounding thing, or a speed of the surrounding thing, or any combination thereof, based on that a pulse laser signal radiated from the LiDAR 120 is reflected from the surrounding object to return.

The memory 130 included in the vehicle control apparatus 100 may include a hardware component for storing data and/or an instruction input and/or output from the processor 110 of the vehicle control apparatus 100.

For example, the memory 130 may include a volatile memory including a random-access memory (RAM) or a non-volatile memory including a read-only memory (ROM).

For example, the volatile memory may include at least one of a dynamic RAM (DRAM), a static RAM (SRAM), a cache RAM, or a pseudo SRAM (PSRAM), or any combination thereof. However, it is not limited thereto.

For example, the non-volatile memory may include at least one of a programmable ROM (PROM), an erasable PROM (EPROM), an electrically erasable PROM (EEPROM), a flash memory, a hard disk, a compact disc, a solid state drive (SSD), or an embedded multi-media card (eMMC), or any combination thereof. However, it is not limited thereto.

The processor 110 included in the vehicle control apparatus 100 may obtain a plurality of frames using the LiDAR 120 while the vehicle is operating. For example, the processor 110 may identify a virtual box corresponding to an external vehicle, in the plurality of frames. Hereinafter, operations performed by the processor 110 in two sequential frames may be referred to as operations performed by the processor 110 in the plurality of frames.

For example, the processor 110 may identify a virtual box corresponding to an external vehicle, in two sequential frames among the plurality of frames obtained using the sensor (e.g., LiDAR 120). The processor 110 may apply at least one of an iterative closest point (ICP) algorithm or simultaneous localization and mapping (SLAM), or any combination thereof to the virtual box corresponding to the external vehicle. For example, the processor 110 may apply a specified algorithm to the virtual box corresponding to the external vehicle to obtain a first vector. For example, the specified algorithm may include at least one of the ICP algorithm or the SLAM, or any combination thereof.

For example, when there are two point clouds scanned at different points for a target (e.g., the external vehicle), the ICP algorithm may include an algorithm for registering two pieces of data.

For example, the ICP algorithm may include an algorithm for matching the closest point in a reference point cloud with respective points included in a first source point cloud and a second source point cloud and estimating a combination of rotation and conversion using the root mean square using a distance metric minimization technique between each source point and a point which is most matched with a match item obtained in a previous stage.

For example, the distance metric minimization technique may include an operation of repeatedly performing conversion necessary to minimize a distance between two point clouds.

For example, the distance metric minimization technique may include an operation of matching the closest point from a second point with a first point cloud among the two point clouds, an operation of estimating a combination of rotation and conversion of the second point cloud, and an operation of converting a source point using the obtained conversion. For example, the source point may include a point matched with the first point cloud in the above-mentioned second point cloud.

For example, the processor 110 may apply the ICP algorithm to the virtual box corresponding to the external vehicle to obtain the first vector.

For example, the processor 110 may identify a sampling point of the virtual box included in the two sequential frames. For example, the sampling point may include at least some of points for forming the virtual box. For example, the processor 110 may apply the ICP algorithm to the sampling point of the virtual box included in the two sequential frames. The processor 110 may obtain the first vector based on applying the ICP algorithm to the sampling point of the virtual box included in the two sequential frames.

For example, the first vector may be referred to as an ICP heading vector. The processor 110 may store the obtained first vector in the memory 130, based on applying the ICP algorithm to the virtual box corresponding to the external vehicle to obtain the first vector.

The processor 110 may relatively more accurately identify the first vector of the virtual box identified in a current frame, using the first vector (or the first vectors) stored in the memory 130.

For example, the processor 110 may store the first vector obtained by applying the specified algorithm to the virtual box corresponding to the external vehicle in a specified area in the memory 130. For example, the processor 110 may identify directivity of the first vector. The processor 110 may store the first vector in the specified area in the memory 130, which corresponds to the directivity of the first vector, based on identifying the directivity of the first vector.

For example, the processor 110 may identify an amount of movement in which the virtual box corresponding to the external vehicle moves in the two sequential frames. For example, the amount of movement in which the virtual box corresponding to the external vehicle moves in the two sequential frames may include a displacement in which the virtual box moves in the frames. For example, the processor 110 may identify a displacement in which the virtual box moves in the two sequential frames, using a representative point included in the virtual box corresponding to the external vehicle. For example, the processor 110 may obtain the amount of movement in which the virtual box corresponding to the external vehicle moves in the two sequential frames, based on identifying the displacement in which the virtual box moves in the two sequential frames, using the representative point included in the virtual box corresponding to the external vehicle.

For example, the processor 110 may identify at least one of an amount of change in x-component (e.g., along an X-axis) or an amount of change in y-component (e.g., along a Y-axis), which is included in the amount of movement in which the virtual box corresponding to the external vehicle moves in the two sequential frames, or any combination thereof.

The processor 110 may identify directivity indicated by the virtual box, based on the at least one of the amount of change in x-component or the amount of change in y-component, which is included in the amount of movement in which the virtual box corresponding to the external vehicle moves in the two sequential frames, or any combination thereof. The processor 110 may store the first vector in the specified area in the memory 130, based on the identified directivity.

The processor 110 may store the first vector in one of a first specified area indicating a positive direction of an x-axis, a second specified area indicating a positive direction of a y-axis, a third specified area indicating a negative direction of the y-axis, or a fourth specified area indicating a negative direction of the x-axis.

For example, when the first vector indicates the positive direction of the x-axis, the processor 110 may store the first vector in the first specified area in the memory 130. For example, when the first vector indicates the positive direction of the y-axis, the processor 110 may store the first vector in the second specified area in the memory 130. For example, when the first vector indicates the negative direction of the y-axis, the processor 110 may store the first vector in the third specified area in the memory 130. For example, when the first vector indicates the negative direction of the x-axis, the processor 110 may store the first vector in the fourth specified area in the memory 130. However, it is not limited thereto.

The processor 110 may obtain a second vector including the heading direction of the virtual box, using the first vector stored in the memory 130. The processor 110 may obtain the second vector including the heading direction of the virtual box, using the first vector stored in the memory 130, to relatively more accurately identify a direction of the second vector.

The processor 110 may obtain the second vector indicating the direction of progress of the external vehicle, based on at least one of the first vector or a speed of the vehicle, or any combination thereof. In detail, the processor 110 may obtain the second vector indicating the direction of progress of the external vehicle, based on the first vector and a velocity vector corresponding to the speed of the vehicle.

The processor 110 may obtain a third vector including the heading direction of the virtual box, based on an angle between a straight line perpendicular to one side of the virtual box and the second vector.

The processor 110 may store a plurality of vectors including the third vector in the memory 130. For example, the processor 110 may store the plurality of vectors including the third vector in the memory 130 to track the heading direction of the virtual box.

For example, the processor 110 may identify the angle between the straight line perpendicular to the one side of the virtual box and the second vector. The processor 110 may identify the heading direction of the virtual box, based on identifying one side of a virtual box, which has the smallest angle between the straight line perpendicular to the one side of the virtual box and the second vector. The processor 110 may obtain the third vector including the heading direction of the virtual box, based on identifying the heading direction of the virtual box.

The processor 110 may obtain a measure of dispersion (e.g., an amount of dispersion) using the plurality of vectors (or the third vectors) including the third vector, which are identified in the plurality of frames. For example, the measure of dispersion (e.g., the amount of dispersion) may include at least one of a deviation, a variation, or a standard deviation, or any combination thereof.

The processor 110 may determine reliability (e.g., a reliability range or a range in which accuracy of vectors are considered to be above a predetermined level of reliability), based on the measure of dispersion (e.g., the amount of dispersion) obtained using (e.g., indicated by) the plurality of vectors including the third vector. For example, high reliability may indicate a low degree of variation (e.g., low variability) in the measure of dispersion (e.g., the amount of dispersion), and low reliability may indicate a high degree of variation (e.g., high variability) in the measure of dispersion (e.g., the amount of dispersion).

For example, the processor 110 may set the reliability of about 70% by default. The processor 110 may change the reliability, based on at least one of a speed of the external vehicle corresponding to the virtual box or a size of the external vehicle, or any combination thereof.

After setting the reliability of about 70% by default, the processor 110 may change the reliability, based on the at least one of the speed of the external vehicle corresponding to the virtual box or the size of the external vehicle, or the any combination thereof. For example, after setting the reliability of about 70% by default, the processor 110 may change the reliability to the largest reliability among first reliability, second reliability, third reliability, and fourth reliability, based on the at least one of the speed of the external vehicle corresponding to the virtual box or the size of the external vehicle, or the any combination thereof.

For example, when the speed of the external vehicle corresponding to the virtual box is less than or equal to a specified speed, the processor 110 may change the reliability to the reliability of about 50%. For example, the reliability capable of changing when the speed of the external vehicle corresponding to the virtual box is less than or equal to the specified speed may include the first reliability.

For example, when the speed of the external vehicle corresponding to the virtual box is greater than the specified speed, the processor 110 may change the reliability to the reliability of about 80%. For example, the reliability capable of changing when the speed of the external vehicle corresponding to the virtual box is greater than the specified speed may include the second reliability.

For example, when the length of the longest side of the virtual box is greater than or equal to about 4 meters (m), the processor 110 may change the reliability to the reliability of about 80%. For example, the reliability capable of changing when the length of the longest side of the virtual box is greater than or equal to about 4 m may include the third reliability.

For example, when the length of the longest side of the virtual box is less than about 4 m, the processor 110 may change the reliability to the reliability of about 60%. For example, the reliability capable of changing when the length of the longest side of the virtual box is less than about 4 m may include the fourth reliability.

The processor 110 may identify a heading direction of the virtual box, which deviates from the reliability determined based on the measure of dispersion. The processor 110 may adjust (e.g., correct) the heading direction of the virtual box, using some of the plurality of vectors included in the reliability, based on identifying the heading direction of the virtual box, which deviates from the determined reliability.

For example, the processor 110 may obtain an average of all or some of the plurality of vectors included in the reliability. The processor 110 may adjust (e.g., correct) the heading direction of the virtual box, based on the average of the all or some of the plurality of vectors included in the reliability.

For example, the processor 110 may obtain (or generate) a fourth vector corresponding to the average of the all or some of the plurality of vectors included in the reliability. For example, the fourth vector may include a vector obtained (or generated) to perform the same operations as operations which use the second vector.

The processor 110 may obtain a fifth vector including the heading direction of the virtual box and may adjust (e.g., correct) the heading direction of the virtual box, based on an angle between a straight line perpendicular to one side of the virtual box and the fourth vector.

The processor 110 may fail to store the fifth vector including the adjusted (e.g., corrected) heading direction of the virtual box in the memory 130. The processor 110 may fail to store the fifth vector including the adjusted (e.g., corrected) heading direction in the memory 130, thus failing to use the fifth vector, when obtaining the reliability.

As described above, the vehicle control apparatus 100 may adjust (e.g., correct) the heading direction based on identifying the heading direction of the virtual box corresponding to the external vehicle. The vehicle control apparatus 100 may adjust (e.g., correct) the heading direction of the virtual box corresponding to the external vehicle, thus preventing an accident from occurring. The vehicle control apparatus 100 may adjust (e.g., correct) the heading direction of the virtual box corresponding to the external vehicle, thus relatively more accurately tracking the external vehicle corresponding to the virtual box.

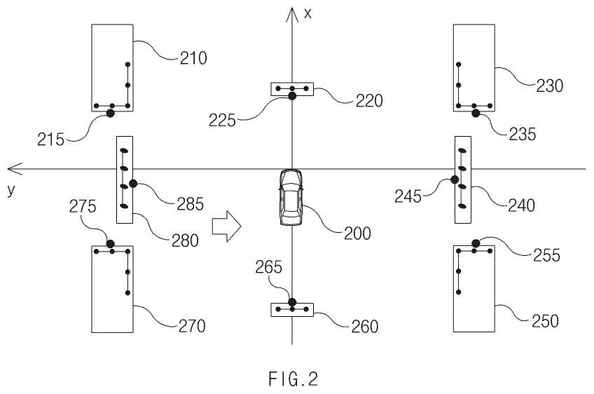

FIG. 2 illustrates an example associated with a representative point of a virtual box corresponding to an external object using a sensor (e.g., a LiDAR) included in a vehicle control apparatus.

A vehicle 200 of FIG. 2 may include a vehicle control apparatus 100 of FIG. 1. Operations of FIG. 2 may be performed by the vehicle control apparatus 100 of FIG. 1 or a processor 110 included in the vehicle control apparatus 100 of FIG. 1.

Referring to FIG. 2, a processor of a vehicle control apparatus may obtain datasets from a sensor (e.g., a LiDAR). For example, the datasets obtained from the sensor (e.g., LiDAR) may include a point cloud based on a three-dimensional (3D) virtual coordinate system. For example, the point cloud based on the 3D virtual coordinate system may be formed by light reflected from an external object including an external vehicle. The processor may obtain a virtual box corresponding to the external vehicle, using the point cloud based on the 3D virtual coordinate system.

The processor may project the virtual box onto a two-dimensional (2D) virtual coordinate system including an x-axis and a y-axis, based on obtaining the virtual box corresponding to the external vehicle using the point cloud included in the 3D virtual coordinate system.

The processor may form the virtual box corresponding to the external vehicle on the 2D virtual coordinate system including the x-axis and the y-axis, using the datasets obtained from the sensor (e.g., LiDAR).

The processor may identify a representative point included in the virtual box corresponding to the external vehicle, in the 2D virtual coordinate system. Hereinafter, a description will be given below of example embodiments of identifying the representative point based on the position of the virtual box included in the 2D virtual coordinate system.

The processor may identify a virtual box 210 in a positive direction of the x-axis and a positive direction of the y-axis. The processor may identify a representative point 215 included at a lower side of the virtual box 210, based on identifying the virtual box 210 in the positive direction of the x-axis and the positive direction of the y-axis.

The processor may identify a virtual box 220 on the x-axis. For example, the processor may identify the virtual box 220 in which an x-coordinate has a positive value, on the x-axis. The processor may identify a representative point 225 included at a lower side of the virtual box 220, based on identifying the virtual box 220 in which the x-coordinate has the positive value on the x-axis.

The processor may identify a virtual box 230 in the positive direction of the x-axis and a negative direction of the y-axis. The processor may identify a representative point 235 included at a lower side of the virtual box 230, based on identifying the virtual box 230 in the positive direction of the x-axis and the negative direction of the y-axis.

The processor may identify a virtual box 240 on the y-axis. For example, the processor may identify the virtual box 240 in which a y-coordinate has a negative value on the y-axis. The processor may identify a representative point 245 included on a left side of the virtual box 240, based on identifying the virtual box 240 in which the y-coordinate has the negative value on the y-axis.

The processor may identify a virtual box 250 in a negative direction of the x-axis and the negative direction of the y-axis. The processor may identify a representative point 255 included at an upper side of the virtual box 250, based on identifying the virtual box 250 in the negative direction of the x-axis and the negative direction of the y-axis.

The processor may identify a virtual box 260 on the x-axis. For example, the processor may identify the virtual box 260 in which the x-coordinate has a negative value on the x-axis. The processor may identify a representative point 265 included at an upper side of the virtual box 260, based on identifying the virtual box 260 in which the x-coordinate has the negative value on the x-axis.

The processor may identify a virtual box 270 in the negative direction of the x-axis and the positive direction of the y-axis. The processor may identify a representative point 275 included at an upper side of the virtual box 270, based on identifying the virtual box 270 in the negative direction of the x-axis and the positive direction of the y-axis.

The processor may identify a virtual box 280 on the y-axis. For example, the processor may identify the virtual box 280 in which the y-coordinate has a positive value on the y-axis. The processor may identify a representative point 285 included on a right side of the virtual box 280, based on identifying the virtual box 280 in which the y-coordinate has the positive value on the y-axis.

The processor may obtain a first vector based on movement of the representative point, based on identifying the representative point of the virtual box. The processor may obtain a second vector indicating the direction of progress of an external vehicle corresponding to the virtual box using the first vector, may obtain a third vector including the heading direction of the virtual box using the obtained second vector, and may adjust (e.g., correct) the heading direction of the virtual box using a plurality of vectors including the third vector.

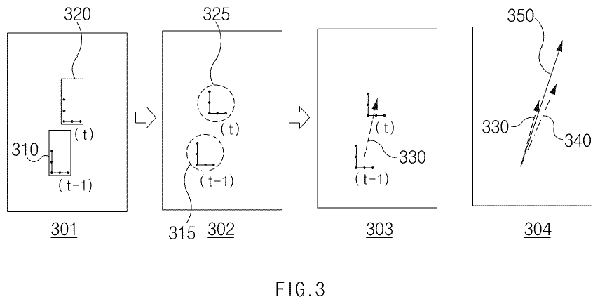

FIG. 3 illustrates an example of obtaining a vector indicating the direction of progress of an external vehicle.

Operations of FIG. 3 may be performed by a vehicle control apparatus 100 of FIG. 1. The operations of FIG. 3 may be performed by a processor 110 included in the vehicle control apparatus 100 of FIG. 1.

Referring to FIG. 3, in a first order 301, a processor of a vehicle control apparatus may identify virtual boxes 310 and 320 corresponding to external vehicles, in two sequential frames. For example, the processor may identify the first virtual box 310 in a first frame and may identify the second virtual box 320 in a second frame rate. For example, the first frame may include a frame prior to the second frame.

In a second order 302, the processor may identify a first portion 315 in a point cloud included in the first virtual box 310 and may identify a second portion 325 in a point cloud included in the second virtual box 320. The processor may apply an ICP algorithm to the first portion 315 and the second portion 325.

In a third order 303, the processor may obtain a first vector 330, based on applying the ICP algorithm to the first portion 315 and the second portion 325. For example, the first vector 330 may be referred to as an ICP vector.

For example, the processor may obtain the first vector 330 based on an amount of movement of the external vehicle, which is obtained by means of a displacement in which the virtual boxes 310 and 320 move in the two sequential frames, using representative points included in the virtual boxes 310 and 320.

The processor may obtain the first vectors respectively in a plurality of frames. The processor may store the first vectors obtained respectively in the plurality of frames in a memory. For example, the processor may identify directivity of the first vectors obtained respectively in the plurality of frames and may sequentially store the first vectors in a specified area of the memory, based on the identified directivity.

In a fourth order 304, the processor may obtain a second vector 350, based on the first vector 330 and a speed 340 of a vehicle. For example, the processor may synthesize the first vector 330 and the speed 340 of the vehicle to obtain the second vector 350. For example, the processor may obtain the second vector 350 indicating the direction of progress of the external vehicle, based on synthesizing the first vector 330 and the speed 340 of the vehicle.

The processor may obtain the second vector 350, based on the first vectors stored in the memory and the speed 340 of the vehicle. For example, the processor may obtain the second vector 350 indicating the direction of progress of the external vehicle, based on all or some of the first vectors stored in the memory and the speed 340 of the vehicle.

The processor may obtain a third vector including a heading direction of a virtual box, based on an angle between the second vector 350 and a straight line perpendicular to one side of the virtual box, and may adjust (e.g., correct) the heading direction of the virtual box using a plurality of vectors including the obtained third vector.

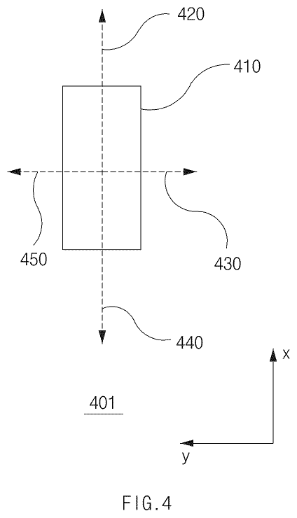

FIG. 4 illustrates an example of directivity of an external vehicle corresponding to a virtual box.

Operations of FIG. 4 may be performed by a vehicle control apparatus 100 of FIG. 1. The operations of FIG. 4 may be performed by a processor 110 included in the vehicle control apparatus 100 of FIG. 1.

Referring to FIG. 4, a processor may identify directivity indicated by an external vehicle corresponding to a virtual box 410, in a 2D virtual coordinate system 401 formed by an x-axis and a y-axis.

The directivity of the external vehicle corresponding to the virtual box 410 may include a first direction 420, a second direction 430, a third direction 440, and a fourth direction 450. For example, the first direction 420 may include a positive direction of the x-axis. For example, the second direction 430 may include a negative direction of the y-axis. For example, the third direction 440 may include a negative direction of the x-axis. For example, the fourth direction 450 may include a positive direction of the y-axis.

For example, the first direction 420 may indicate that the external vehicle is facing the front. For example, the second direction 430 may indicate that the external vehicle is facing the right. For example, the third direction 440 may indicate that the external vehicle is facing the rear. For example, the fourth direction 450 may indicate that the external vehicle is facing the left.

For example, the processor may identify an amount of movement of the external vehicle, in two sequential frames among a plurality of frames obtained using a sensor (e.g., a LiDAR). The processor may identify directivity, based on the amount of movement of the external vehicle.

For example, the amount of movement of the external vehicle may include an amount of change in x-component of the virtual box 410 corresponding to the external vehicle and an amount of change in y-component of the virtual box 410 corresponding to the external vehicle.

For example, the processor may identify directivity of the external vehicle, based on an amount of change with a larger absolute value between the amount of change in x-component of the virtual box 410 corresponding to the external vehicle and the amount of change in y-component of the virtual box 410 corresponding to the external vehicle.

For example, when the absolute value of the amount of change in x-component is greater than an absolute value of the amount of change in y-component, the processor may identify that the directivity of the external vehicle is one of the first direction 420 indicating the front of the external vehicle or the third direction 440 indicating the rear of the external vehicle. For example, when the amount of change in x-component has a positive value and when the absolute value of the amount of change in x-component is greater than the absolute value of the amount of change in y-component, the processor may identify that the directivity of the external vehicle is the first direction 420 indicating the front of the external vehicle. For example, when the amount of change in x-component has a negative value and when the absolute value of the amount of change in x-component is greater than the absolute value of the amount of change in y-component, the processor may identify that the directivity of the external vehicle is the third direction 440 indicating the rear of the external vehicle.

For example, when the absolute value of the amount of change in y-component is greater than the absolute value of the amount of change in x-component, the processor may identify that the directivity of the external vehicle is one of the second direction 430 indicating the right of the external vehicle or the fourth direction 450 indicating the left of the external vehicle. For example, when the amount of change in y-component has a negative value and when the absolute value of the amount of change in y-component is greater than the absolute value of the amount of change in x-component, the processor may identify that the directivity of the external vehicle is the second direction 430 indicating the right of the external vehicle. For example, when the amount of change in y-component has a positive value and when the absolute value of the amount of change in y-component is greater than the absolute value of the amount of change in x-component, the processor may identify that the directivity of the external vehicle is the fourth direction 450 indicating the left of the external vehicle.

The directivity of the external vehicle may be identified as one of the first direction 420, the second direction 430, the third direction 440, and the fourth direction 450. Furthermore, the directivity of the external vehicle may transition to directivity different from the initially identified directivity.

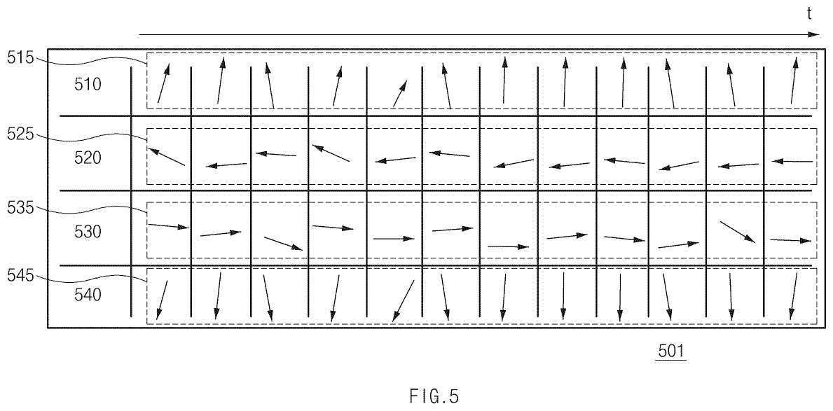

FIG. 5 illustrates an example of vectors including a heading direction of a virtual box stored in a memory.

Operations of FIG. 5 may be performed by a vehicle control apparatus 100 of FIG. 1. The operations of FIG. 5 may be performed by a processor 110 included in the vehicle control apparatus 100 of FIG. 1.

Referring to FIG. 5, a processor may classify and sequentially store first vectors obtained by applying an ICP algorithm in one of a plurality of areas 510, 520, 530, and 540 of a memory 501.

The processor may sequentially store the first vectors in one of the plurality of areas 510, 520, 530, and 540 which correspond to directivity of an external vehicle and are formed in the memory 501, based on identifying the directivity of the external vehicle.

For example, the processor may identify that the directivity of the external vehicle is a first direction indicating the front of the external vehicle. The processor may sequentially store first vectors 515 in the first area 510 corresponding to the first direction, based on identifying that the directivity of the external vehicle is the first direction indicating the front of the external vehicle.

For example, the processor may identify that the directivity of the external vehicle is a second direction indicating the left of the external vehicle. The processor may sequentially store first vectors 525 in the second area 520 corresponding to the second direction, based on identifying that the directivity of the external vehicle is the second direction indicating the left of the external vehicle.

For example, the processor may identify that the directivity of the external vehicle is a third direction indicating the right of the external vehicle. The processor may sequentially store first vectors 535 in the third area 530 corresponding to the third direction, based on identifying that the directivity of the external vehicle is the third direction indicating the right of the external vehicle.

For example, the processor may identify that the directivity of the external vehicle is a fourth direction indicating the rear of the external vehicle. The processor may sequentially store first vectors 545 in the fourth area 540 corresponding to the fourth direction, based on identifying that the directivity of the external vehicle is the fourth direction indicating the rear of the external vehicle.

The processor may delete (or initialize) the first vectors stored in a specified area, based on that the directivity of the external vehicle is changed, and may store the first vectors including the changed directivity in an area different from the specified area.

The processor may obtain a second vector indicating the direction of progress of the external vehicle, using the stored first vectors. The operation of obtaining the second vector may include an operation of obtaining the second vector in a fourth order 304 of FIG. 3.

As described above, the processor may classify and store the first vector in the specified area of the memory, based on the identified directivity. The processor may classify and store the first vector, thus relatively more accurately identifying an amount of movement of the external vehicle at a current time point.

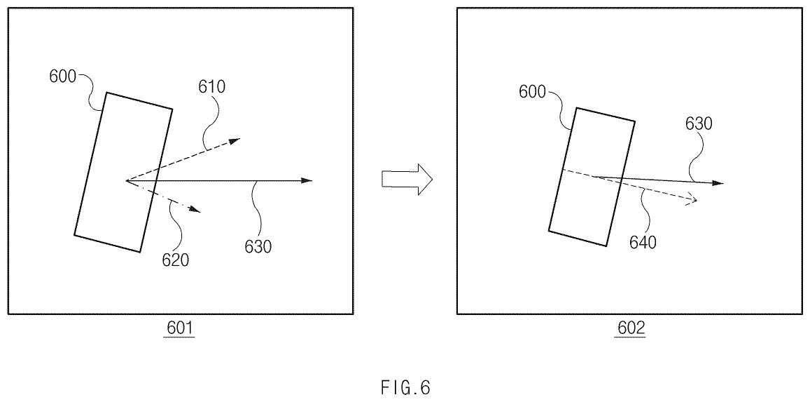

FIG. 6 illustrates an example of obtaining a vector including a heading direction of a virtual box.

Operations of FIG. 6 may be performed by a vehicle control apparatus 100 of FIG. 1. The operations of FIG. 6 may be performed by a processor 110 included in the vehicle control apparatus 100 of FIG. 1.

Referring to FIG. 6, in a first example 601, a processor may obtain vectors 610, 620, and 630 associated with an external vehicle corresponding to a virtual box 600. For example, the processor may obtain the first vector 610, based on applying an ICP algorithm to a plurality of points included in the virtual box 600.

The processor may identify the velocity vector 620 indicating a speed of the vehicle. The processor may synthesize the first vector 610 obtained by means of the ICP algorithm and the velocity vector 620 indicating the speed of the vehicle. The processor may obtain the second vector 630 indicating the direction of progress of the external vehicle, based on synthesizing the first vector 610 obtained by means of the ICP algorithm and the velocity vector 620 indicating the speed of the vehicle.

In a second example 602, the processor may obtain a third vector 640 including a heading direction of the virtual box 600, using the second vector 630. For example, the processor may obtain the third vector 640 including the heading direction of the virtual box 600, based on an angle between a straight line perpendicular to one side of the virtual box 600 and the second vector 630.

For example, the processor may identify the angle between the straight line perpendicular to the one side of the virtual box 600 and the second vector 630. The processor may identify one side of the virtual box 600, which has the smallest angle between the straight line perpendicular to the one side of the virtual box 600 and the second vector 630. The processor may identify the heading direction of the virtual box 600, based on identifying the one side of the virtual box 600, which has the smallest angle between the straight line perpendicular to the one side of the virtual box 600 and the second vector 630. The processor may obtain the third vector 640 including the heading direction of the virtual box 600, based on identifying the heading direction of the virtual box 600, by means of the one side of the virtual box 600, which has the smallest angle between the straight line perpendicular to the one side of the virtual box 600 and the second vector 630.

The processor may store third vectors identified respectively in a plurality of frames in a memory. For example, the processor may store the virtual box and the third vector 640 as one set in the memory, based on identifying the third vector 640 including the heading direction of the virtual box identified in each of the plurality of frames.

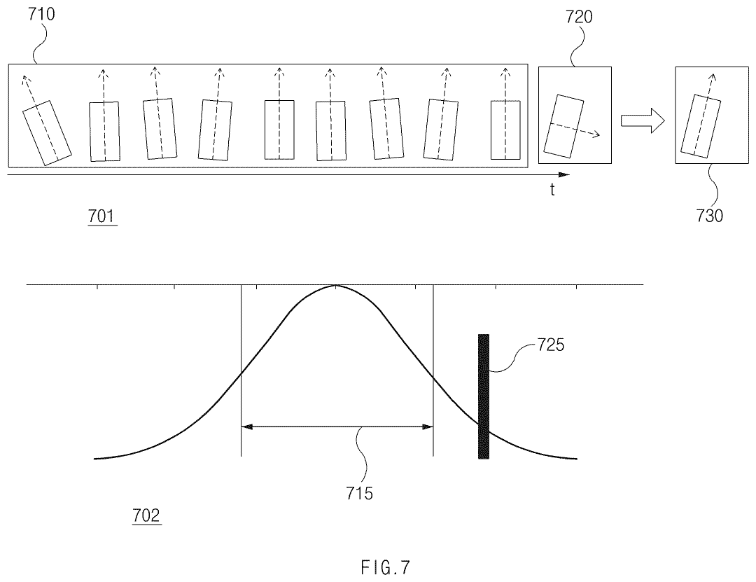

FIG. 7 illustrates an example of adjusting (e.g., correcting) a heading direction of a virtual box.

Operations of FIG. 7 may be performed by a vehicle control apparatus 100 of FIG. 1. The operations of FIG. 7 may be performed by a processor 110 included in the vehicle control apparatus 100 of FIG. 1.

Referring to FIG. 7, a first example 701 may include an example of a plurality of vectors 710 including heading directions of virtual boxes stored in a memory. A second example 702 may include an example indicating a measure of dispersion obtained using (e.g., indicated by) the plurality of vectors 710.

Referring to FIG. 7, a processor may identify the plurality of vectors 710 in a plurality of frames. For example, the plurality of vectors 710 identified in the plurality of frames may include a third vector including a heading direction of a virtual box identified in each of the plurality of frames. The processor may obtain a measure of dispersion, using (e.g., indicated by) the plurality of vectors 710. For example, the measure of dispersion may include at least one of a deviation, a variation, or a standard deviation, or any combination thereof.

The second example 702 of FIG. 7 includes, but is not limited to, an example using a variation obtained using the plurality of vectors 710.

The processor may determine reliability 715 (e.g., a reliable range), based on the variation obtained using the plurality of vectors 710. For example, the reliability 715 may be to identify whether the direction of a third vector 720 including the heading direction of the virtual box, which is identified in a current frame, is accurate.

The processor may identify the third vector 720 including the heading direction of the virtual box in the current frame. The processor may identify that the third vector 720 including the heading direction of the virtual box in the current frame deviates from the reliability 715 obtained by the plurality of vectors 710. For example, the processor may identify a vector value 725 of the third vector 720. The processor may identify that the vector value 725 of the third vector 720 deviates from the reliability 715. That the vector value 725 of the third vector 720 deviates from the reliability 715 may means that the heading direction of the virtual box is incorrectly identified.

The processor may correct the heading direction of the virtual box using all or some of the plurality of vectors 710 included in the reliability 715, based on identifying the heading direction of the virtual box, which deviates from the reliability 715.

For example, the processor may obtain a fourth vector, based on an average of the all or some of the plurality of vectors 710. The processor may obtain a fifth vector 730 including the heading direction of the virtual box and may correct the heading direction of the virtual box, based on an angle between a straight line perpendicular to one side of the virtual box and the fourth vector.

The processor may exclude the fifth vector 730 with the corrected heading direction from being stored in a memory. For example, a vehicle control apparatus may include the memory which stores the plurality of vectors 710. The processor may be configured such that the corrected heading direction of the virtual box is not included in (e.g., excluded from) the plurality of vectors 710.

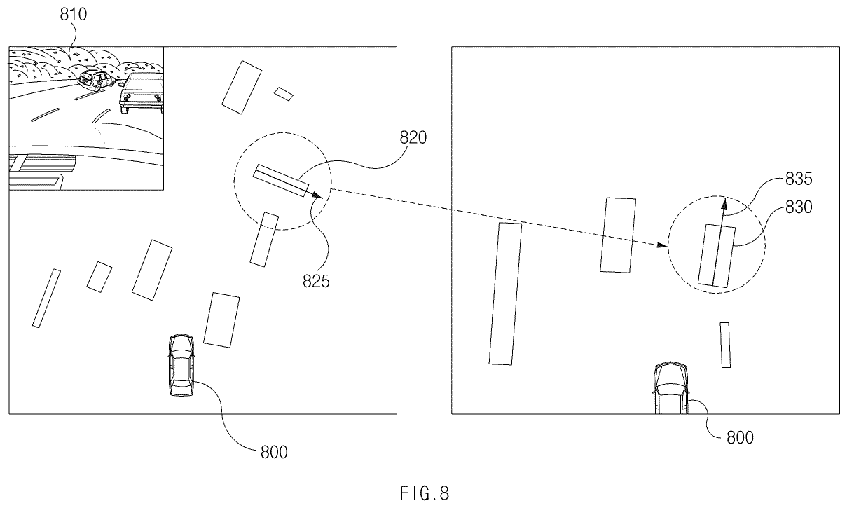

FIG. 8 illustrates an example of a result of correcting a heading direction of a virtual box.

Operations of FIG. 8 may be performed by a vehicle control apparatus 100 of FIG. 1. The operations of FIG. 8 may be performed by a processor 110 included in the vehicle control apparatus 100 of FIG. 1.

A processor of a vehicle control apparatus may obtain image information 810 using a sensor (e.g., a LiDAR) or a camera included in a vehicle 800. The processor may identify a virtual box 820 corresponding to an external vehicle, from the image information 810. For example, while operating in a driving aid activation mode or an autonomous driving mode, the processor may identify the virtual box 820 corresponding to the external vehicle and may identify a heading direction 825 of the virtual box 820.

The processor may correct the heading direction 825 of the virtual box 820. For example, the processor may apply an ICP algorithm to points included in the virtual box 820 to obtain a first vector, in a plurality of frames included in the image information 810. The processor may synthesize the first vector and a speed of the vehicle 800 to obtain a second vector. For example, the processor may obtain a third vector including the heading direction 825 of the virtual box 820, based on an angle between a straight line perpendicular to one side of the virtual box 820 and the second vector.

The processor may determine reliability, based on a variation obtained using a plurality of vectors including the third vector, which are identified in the plurality of frames included in the image information 810. The processor may correct the heading direction 825 of the virtual box 820, using all or some of the plurality of vectors included in the reliability, based on identifying the heading direction 825 of the virtual box 820, which deviates from the determined reliability.

For example, the processor may obtain a fourth vector, based on an average of the all or some of the plurality of vectors. The processor may obtain a fifth vector including a heading direction 835 of a virtual box 830, based on an angle between a straight line perpendicular to one side of the virtual box 820 and the fourth vector, and may correct the heading direction 825 of the virtual box 820.

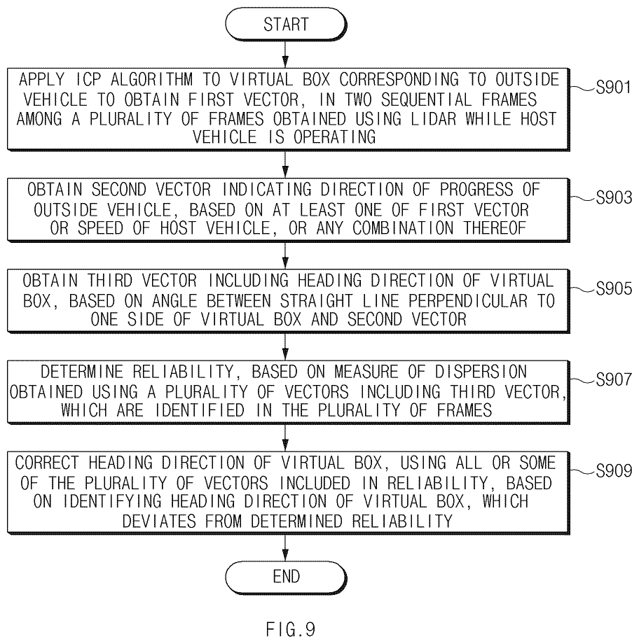

FIG. 9 illustrates an example of a flowchart about a vehicle control method.

Hereinafter, it is assumed that a vehicle control apparatus 100 of FIG. 1 performs a process of FIG. 9. Furthermore, in a description of FIG. 9, an operation described as being performed by a processor of a vehicle control apparatus may be understood as being controlled by a processor 110 of the vehicle control apparatus 100.

At least one of the operations of FIG. 9 may be performed by the vehicle control apparatus 100 of FIG. 1. The respective operations of FIG. 9 may be sequentially performed, but are not necessarily sequentially performed. For example, an order of the respective operations may be changed, and at least two operations may be performed in parallel.

Referring to FIG. 9, in S901, a processor of a vehicle control apparatus may apply an ICP algorithm to a virtual box corresponding to an external vehicle to obtain a first vector, in two sequential frames among a plurality of frames obtained using a sensor (e.g., a LiDAR) while a vehicle is operating. For example, the two sequential frames among the plurality of frames may include two consecutive frames.

For example, the processor may identify a displacement in which the virtual box moves in the two sequential frames, using a representative point included in the virtual box. The processor may identify an amount of movement of the external vehicle, which is obtained by means of the displacement in which the virtual box moves in the two sequential frames, using the representative point included in the virtual box.

The processor may obtain the first vector based on the amount of movement of the external vehicle, which is obtained by means of the displacement in which the virtual boxes move in the two sequential frames, using the representative point included in the virtual box.

For example, the processor may obtain the first vector, based on applying the ICP algorithm to a sampling point of the virtual box included in the two sequential frames, and may store the obtained first vector in a memory.

The processor may sequentially store the first vector obtained in the plurality of frames in the memory.

In S903, the processor of the vehicle control apparatus may obtain a second vector indicating the direction of progress of the external vehicle, based on at least one of the first vector or a speed of the vehicle, or any combination thereof.

For example, the processor may obtain the second vector indicating the direction of progress of the external vehicle, based on synthesizing the first vector obtained by applying the ICP algorithm to the virtual box corresponding to the external vehicle and a velocity vector corresponding to the speed of the vehicle.

In S905, the processor of the vehicle control apparatus may obtain a third vector including a heading direction of the virtual box, based on an angle between a straight line perpendicular to one side of the virtual box and the second vector.

For example, the processor may identify one side of the virtual box, which has the smallest angle (e.g., among all the sides of the virtual box) between the straight line perpendicular to the one side of the virtual box and the second vector. The processor may identify the heading direction of the virtual box, which is formed across the virtual box, from the one side of the virtual box, which has the smallest angle between the straight line perpendicular to the one side of the virtual box and the second vector. The processor may obtain the third vector including the heading direction of the virtual box, which is formed across the virtual box, from the one side of the virtual box, which has the smallest angle between the straight line perpendicular to the one side of the virtual box and the second vector.

In S907, the processor of the vehicle control apparatus may determine reliability, based on a measure (e.g., an amount) of dispersion obtained using a plurality of vectors including the third vector, which are identified in the plurality of frames.

In S909, the processor of the vehicle control apparatus may correct the heading direction of the virtual box, using all or some of the plurality of vectors included in the reliability, based on identifying the heading direction of the virtual box, which deviates from the determined reliability.

For example, the processor may perform S901 to S905, using an average of the all or some of the plurality of vectors included in the reliability.

For example, the processor may obtain a fourth vector corresponding to the average of the all or some of the plurality of vectors included in the reliability. The processor may obtain a fifth vector including the heading including virtual box, based on an angle between a straight line perpendicular to one side of the virtual box and the fourth vector.

For example, the processor may obtain the fifth vector including the heading direction of the virtual box, which is formed across one side of the virtual box, which has the smallest angle between the straight line perpendicular to the one side of the virtual box and the fourth vector.

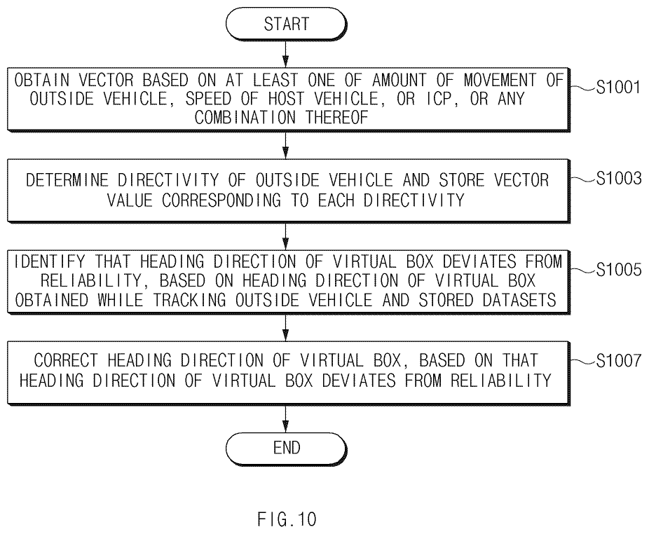

FIG. 10 illustrates an example of a flowchart about a vehicle control method.

Hereinafter, it is assumed that a vehicle control apparatus 100 of FIG. 1 performs a process of FIG. 10. Furthermore, in a description of FIG. 10, an operation described as being performed by a processor of a vehicle control apparatus may be understood as being controlled by a processor 110 of the vehicle control apparatus 100.

At least one of the operations of FIG. 10 may be performed by the vehicle control apparatus 100 of FIG. 1. The respective operations of FIG. 10 may be sequentially performed, but are not necessarily sequentially performed. For example, an order of the respective operations may be changed, and at least two operations may be performed in parallel.

Referring to FIG. 10, in S1001, a processor of a vehicle control apparatus may obtain a vector based on at least one of an amount of movement of an external vehicle, a speed of a vehicle, or an ICP, or any combination thereof.

For example, the vector based on the at least one of the amount of movement of the external vehicle, the speed of the vehicle, or the ICP, or the any combination thereof may include a first vector described with reference to FIGS. 1 to 9. For example, the ICP may correspond to an ICP algorithm.

In S1003, the processor of the vehicle control apparatus may determine directivity of the external vehicle and may store a vector value corresponding to each directivity.

The processor may determine the directivity of the external vehicle using the vector obtained in S1001. For example, the processor may determine the directivity of the external vehicle, based on an amount of change in x-component and an amount of change in y-component, which are included in the vector obtained in S1001. The processor may store the vector value obtained in S1001 in a specified area of a memory, based on identifying the directivity of the external vehicle.

In S1005, the processor of the vehicle control apparatus may identify that a heading direction of a virtual box deviates from reliability, based on the heading direction of the virtual box obtained while tracking the external vehicle and stored datasets.

For example, the heading direction of the virtual box may include a measure of dispersion or a variation described in a second example 702 of FIG. 7.

In S1007, the processor of the vehicle control apparatus may correct the heading direction of the virtual box, based on that the heading direction of the virtual box deviates from the reliability.

For example, the processor may correct the heading direction of the virtual box, using an average of all or some of a plurality of vectors included in the reliability, based on that the heading direction of the virtual box deviates from the reliability.

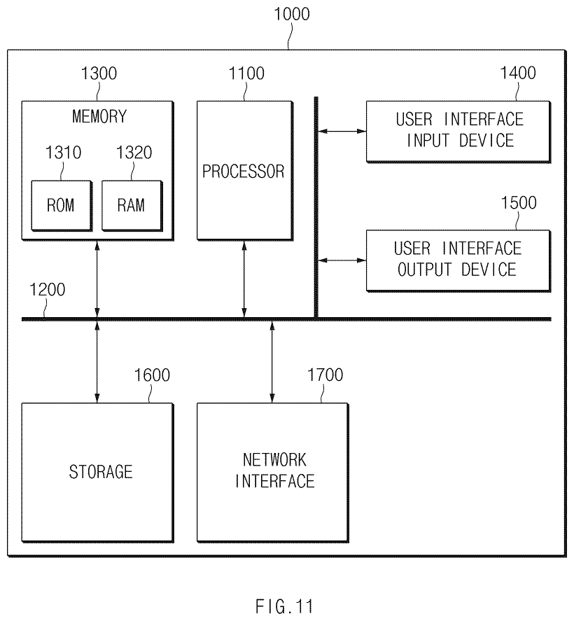

FIG. 11 illustrates a computing system including a vehicle control apparatus.

Referring to FIG. 11, a computing system 1000 may include at least one processor 1100, a memory 1300, a user interface input device 1400, a user interface output device 1500, storage 1600, and a network interface 1700, which are connected with each other via a bus 1200.

The processor 1100 may be a central processing device (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Accordingly, the processes of the method or algorithm described in relation to example embodiments of the present disclosure may be implemented directly by hardware executed by the processor 1100, a software module, or a combination thereof. The software module may reside in a storage medium (that is, the memory 1300 and/or the storage 1600), such as a RAM, a flash memory, a ROM, an EPROM, an EEPROM, a register, a hard disk, solid state drive (SSD), a detachable disk, or a CD-ROM. The exemplary storage medium is coupled to the processor 1100, and the processor 1100 may read information from the storage medium and may write information in the storage medium. In another method, the storage medium may be integrated with the processor 1100. The processor 1100 and the storage medium may reside in an application specific integrated circuit (ASIC). The ASIC may reside in a user terminal. In another method, the processor 1100 and the storage medium may reside in the user terminal as an individual component.

The present technology may correct a heading direction of an external vehicle obtained using a sensor (e.g., a LiDAR).

Furthermore, the present technology may correct a heading direction of a virtual box corresponding to the external vehicle, when the vehicle operates in a driving aid activation mode or an autonomous driving mode, thus preventing an accident.

Furthermore, the present technology may correct the heading direction of the virtual box corresponding to the external vehicle, when the vehicle operates in the driving aid activation mode or the autonomous driving mode, thus preventing the operation of a vehicle control system including the vehicle control apparatus from being stopped.

In addition, various effects ascertained directly or indirectly through the present disclosure may be provided.

Effects obtained by various example embodiments of the disclosure may not be limited to the above, and other effects will be clearly understandable to those having ordinary skill in the art from the following disclosures.

Although example embodiments of the present disclosure have been described for illustrative purposes, those skilled in the art will appreciate that various modifications, additions and substitutions are possible, without departing from the scope and spirit of the disclosure. Therefore, the example embodiments disclosed in the present disclosure are provided for the sake of descriptions, not limiting the technical concepts of the present disclosure, and it should be understood that such example embodiments are not intended to limit the scope of the technical concepts of the present disclosure. The protection scope of the present disclosure should be understood by the claims below, and all the technical concepts within the equivalent scopes should be interpreted to be within the scope of the right of the present disclosure.

What is claimed is:

1. A vehicle control apparatus comprising:
a sensor; and
a processor configured to:
obtain, while a first vehicle is operating and based on a specified algorithm applied to a virtual box corresponding to a second vehicle, a first vector in a plurality of frames that are obtained using the sensor;
obtain, based on at least one of the first vector or a speed of the first vehicle, a second vector indicating a direction of movement of the second vehicle;
obtain a third vector indicating a heading direction of the virtual box, based on an angle between a straight line, perpendicular to one side of the virtual box, and the second vector;
determine a reliability range based on a plurality of vectors comprising the third vector, wherein the plurality of vectors are determined in the plurality of frames; and
adjust, based on the heading direction deviating from the determined reliability range, the heading direction of the virtual box, using at least one of the plurality of vectors.

2. The vehicle control apparatus of claim 1, wherein the processor is configured to obtain the first vector by:
obtaining the first vector further based on an amount of movement of the second vehicle, wherein the amount of movement is obtained based on a displacement, in the plurality of frames, of a representative point included in the virtual box.

3. The vehicle control apparatus of claim 1, further comprising:
memory,
wherein the processor is configured to obtain the first vector by:
obtaining the first vector based on applying the specified algorithm to a sampling point of the virtual box included in the plurality of frames; and
storing the obtained first vector in the memory.

4. The vehicle control apparatus of claim 1, further comprising:
memory,
wherein the processor is further configured to:
determine, based on at least one of an amount of change along an x-axis of the virtual box or an amount of change along a y-axis of the virtual box, directivity indicated by the virtual box; and
classify, based on the determined directivity, and store the obtained first vector in a specified area of the memory.

5. The vehicle control apparatus of claim 1, wherein the processor is configured further to:
adjust the heading direction of the virtual box, based on an average of the at least one of the plurality of vectors.

6. The vehicle control apparatus of claim 1, wherein the processor is further configured to:
change the determined reliability range, based on at least one of a speed of the second vehicle or a size of the virtual box.

7. The vehicle control apparatus of claim 1, further comprising:
memory storing the plurality of vectors,
wherein the processor is further configured to excluding the adjusted heading direction of the virtual box from the plurality of vectors.

8. The vehicle control apparatus of claim 1, wherein the processor is further configured to:
determine the heading direction of the virtual box by determining a side of the virtual box having, among sides of the virtual box, a smallest angle between the straight line, perpendicular to the side of the virtual box, and the second vector.

9. The vehicle control apparatus of claim 1, further comprising:
memory,
wherein the processor is further configured to:
sequentially store the first vector in one of a plurality of areas formed in the memory.

10. The vehicle control apparatus of claim 1, wherein the processor is configured to:
determine the reliability range by determining the reliability range based on a measure of dispersion indicated by the plurality of vectors; and
adjust the heading direction of the virtual box by adjusting the heading direction of the virtual box based on an average, in the measure of dispersion, of the at least one of the plurality of vectors in the reliability range.

11. The vehicle control apparatus of claim 10, wherein the processor is further configured to:
obtain a fourth vector corresponding to the average of the at least one of the plurality of vectors; and
obtain, based on an angle between the straight line and the fourth vector, a fifth vector including the heading direction of the virtual box and adjust the heading direction of the virtual box.

12. A vehicle control method comprising:
obtaining, by a processor while a first vehicle is operating and based on a specified algorithm applied to a virtual box corresponding to a second vehicle, a first vector in a plurality of frames that are obtained using a sensor;
obtaining, based on at least one of the first vector or a speed of the first vehicle, a second vector indicating a direction of movement of the second vehicle;
obtaining a third vector indicating a heading direction of the virtual box, based on an angle between a straight line, perpendicular to one side of the virtual box, and the second vector;
determining a reliability range based on a plurality of vectors comprising the third vector, wherein the plurality of vectors are determined in the plurality of frames; and
adjusting, based on the heading direction deviating from the determined reliability range, the heading direction of the virtual box, using at least one of the plurality of vectors.

13. The vehicle control method of claim 12, wherein the obtaining of the first vector comprises:
obtaining the first vector further based on an amount of movement of the second vehicle, wherein the amount of movement is obtained based on a displacement, in the plurality of frames, of a representative point included in the virtual box.

14. The vehicle control method of claim 12, wherein the obtaining of the first vector comprises:
obtaining the first vector based on applying the specified algorithm to a sampling point of the virtual box included in the plurality of frames; and
storing the obtained first vector in a memory.

15. The vehicle control method of claim 12, further comprising:
determining, based on at least one of an amount of change along an x-axis of the virtual box or an amount of change along a y-axis of the virtual box, directivity indicated by the virtual box; and
classifying, based on the determined directivity, and storing the obtained first vector in a specified area of a memory.

16. The vehicle control method of claim 12, further comprising:
adjusting the heading direction of the virtual box, based on an average of the at least one of the plurality of vectors.

17. The vehicle control method of claim 12, further comprising:
changing the determined reliability range, based on at least one of a speed of the second vehicle or a size of the virtual box.

18. The vehicle control method of claim 12, further comprising:
excluding the adjusted heading direction of the virtual box from being stored in memory.

19. The vehicle control method of claim 12, further comprising:
determining the heading direction of the virtual box by determining a side of the virtual box having, among sides of the virtual box, a smallest angle between the straight line, perpendicular to the side of the virtual box, and the second vector.

20. The vehicle control method of claim 12, further comprising:
determining the reliability range by determining the reliability range based on a measure of dispersion indicated by the plurality of vectors; and
sequentially storing the first vector in one of a plurality of areas formed in memory.
